(19) United States
(12) Patent Application Publication
(10) Pub. No.: US 2006/0159281 A1
(43) Pub. Date: Jul. 20, 2006

(54) Method and apparatus to record a signal using a beam forming algorithm

(76) Inventors: You-kyung Koh, Seoul (KR); Joon-hyun Lee, Seongnam-si (KR); Byeong-Seob Ko, Suwon-si (KR)

Correspondence Address: STANZIONE & KIM, LLP, 919 18TH STREET, N.W., SUITE 440, WASHINGTON, DC, 20006, US

(21) Appl. No.: 11/237,954

(22) Filed: Sep. 29, 2005

(30) Foreign Application Priority Data
Jan. 14, 2005 (KR) 2005-3803

(51) Int. Cl. H04R 3/00; H04R 1/02

(52) U.S. Cl. 381/92; 381/122; 381/91

(57) ABSTRACT

A method and an apparatus to record an audio signal use a beam forming algorithm for at least two microphones. The method includes disposing a plurality of microphones at a plurality of predetermined locations to generate audio signals upon receiving a sound signal output from a sound source, forming a beam from the audio signals by adjusting a delay and a level of the audio signal of each of the plurality of microphones, and adjusting an angle and a width of the beam by a user.

### CROSS-REFERENCE TO RELATED APPLICATIONS

This application claims the priority under 35 U.S.C. §119 from Korean Patent Application No. 2005-3803, filed on Jan. 14, 2005 in the Korean Intellectual Property Office, the disclosure of which is incorporated herein in its entirety by reference.

### BACKGROUND OF THE INVENTION

1. Field of the Invention

The present general inventive concept relates to an apparatus to record a signal and more particularly, to an apparatus to record a signal using at least two microphones and a beam forming algorithm, and a method of recording a signal using the same.

2. Description of the Related Art

Conventionally, a portable recording or reproducing apparatus for recording a sound signal, such as an audio signal, records the sound signal using a small microphone embedded therein. Thus, the recorded sound signal includes a lot of surrounding noise that degrades the quality of the recorded sound signal.

Therefore, a technique to remove the surrounding noise is required. Generally, an apparatus for removing spectral noise uses a spectral subtraction method to remove the surrounding noise.

In the spectral subtraction method, first, an analog signal input from a microphone is converted into a digital signal. Then, the digital signal is divided into frames in the time domain. After that, the digital signal in the frames is processed to reduce information disconnection between frames and distortion of the digital signal. Finally, the digital signal is transformed into a frequency signal using a fast Fourier transform (FFT).

Spectrum information of the frequency signal is composed of magnitude spectrum information and phase spectrum information. The magnitude spectrum information is used in the spectral subtraction method, and the phase spectrum information is used in an inverse fast Fourier transform (IFFT).

In the spectral subtraction method, an estimate of a noise spectrum is subtracted from the magnitude spectrum in which audio signals and noise are mixed. Here, the noise spectrum is the average of the magnitude spectrum in a noise section of the frequency signal.

The estimate of the noise spectrum is similar to a spectrum of an actual noise when a noise characteristic is normal. Therefore, the magnitude spectrum obtained by applying the spectral subtraction method is a magnitude spectrum of a speech signal.

For example, assuming that a spectrum of an input noise+audio signal is Y(w), and an estimate of a noise spectrum is N′(w), a spectrum of a subtracted signal is Y(w)−N′(w). This operation is illustrated in FIGS. 1A and 1B.

As illustrated in FIG. 1A, a section in which the magnitude of the spectrum is negative occurs. That is, the magnitude of the spectrum is replaced with a predetermined positive threshold 110 if the magnitude of the spectrum is smaller than the predetermined positive threshold 110. This operation is illustrated in an Equation (1) below.
If (Y(w)−N′(w))>threshold→Y(w)−N′(w)
If (Y(w)−N′(w))<threshold→threshold (1)

FIG. 1B illustrates a waveform of a spectrum in which the magnitude of the spectrum that is smaller than the predetermined positive threshold 110 is replaced with the predetermined positive threshold 110.

However, after spectral subtraction, isolated musical noise occurs as indicated by three vertical lines, as illustrated in FIG. 1B. The isolated musical noise is defined as frequency components of relatively low levels in a narrow bandwidth, and occurs for a short time and then disappears. The isolated musical noise is heard as an irregular mechanical noise, and especially when signals have a low signal-to-noise ratio (SNR), the isolated musical noise disturbs people's hearing.

Therefore, a conventional portable apparatus for recording a signal does not remove an undesired sound or a noise included in a signal recorded through a small microphone because the conventional portable apparatus for recording the signal cannot process an unnecessary noise that is recorded together with the signal at a recording stage. Consequently, a quality of the recorded signal is very poor, including a lot of noise. Furthermore, even if a noise removing technique is used in the conventional portable apparatus for recording the signal, the musical noise remains in the recorded signal.

### SUMMARY OF THE INVENTION

The present general inventive concept provides a method of recording an audio signal in a portable apparatus using at least two microphones, wherein noise is removed from the audio signal at a recording stage using a beam forming algorithm.

The present general inventive concept also provides an apparatus to record a signal using the above method of recording an audio signal.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of recording an audio signal, the method including disposing a plurality of microphones at a plurality of predetermined locations to generate audio signals upon receiving a sound signal output from a sound source, forming a beam from the audio signals by adjusting a delay and a level of the audio signal received by each of the plurality of microphones, and adjusting an angle and a width of the beam by a user.

The foregoing and/or other aspects of the present general inventive concept may also be achieved by providing an apparatus to record an audio signal, the apparatus including a plurality of microphones that are disposed to predetermined locations to produce audio signals upon receiving a sound signal, a beam forming unit which forms a beam from the audio signals by adjusting a delay and a level of each audio signal of the microphones, a display unit which displays a beam pattern of the beam formed at the beam forming unit, and a beam angle and/or width adjusting unit which transmits a delay value and a level value of each of the audio signals that correspond to an angle and a width adjustment values of the beam output from the beam forming unit.

The foregoing and/or other aspects of the present general inventive concept may also be achieved by providing an apparatus to record an audio signal including a plurality of microphones to receive sound signals from a sound source and to generate audio signals corresponding to the respective sound signals, a beam forming unit to adjust the audio signals according to corresponding ones of predetermined delay values and level values of the audio signal, and a recording unit to record a signal formed from the adjusted audio signals.

The foregoing and/or other aspects of the present general inventive concept may also be achieved by providing a method of recording a signal, the method including receiving sound signals from a sound source and generating audio signals corresponding to the respective sound signals, adjusting the audio signals according to corresponding ones of predetermined delay values and level values of the audio signal, and recording a signal formed from the adjusted audio signals.

The foregoing and/or other aspects of the present general inventive concept may also be achieved by providing a computer readable storage medium having executable codes to perform a method of recording an audio signal, the method including receiving sound signals from a sound source and generating audio signals corresponding to the respective sound signals, adjusting the audio signals according to corresponding ones of predetermined delay values and level values of the audio signal, and recording a signal formed from the adjusted audio signals.

The foregoing and/or other aspects of the present general inventive concept may also be achieved by providing a computer readable storage medium having executable codes to perform a method of recording an audio signal, the method including disposing a plurality of microphones at a plurality of predetermined locations to generate audio signals upon receiving a sound signal output from a sound source, forming a beam from the audio signals by adjusting a delay and a level of audio signal of each of the plurality of microphones, and adjusting an angle and a width of the beam by a user.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B illustrate a spectral subtraction method by showing a spectrum of an audio signal including noise recorded with a conventional apparatus, and a spectrum after a noise spectrum is subtracted from the spectrum of the audio signal;

FIG. 2 is a view of an apparatus to record a signal using a beam forming algorithm according to an embodiment of the present general inventive concept;

FIG. 3 is a front view of the apparatus of FIG. 2;

FIG. 4 is a block diagram of the apparatus of FIG. 2;

FIG. 5A shows waveforms and delay times of audio signals produced by microphones of the apparatus of FIG. 2;

FIG. 5B is a detailed view of a beam forming unit of the apparatus of FIG. 4;

FIGS. 6A and 6B are views of beam forming patterns of a beam forming unit of the apparatus of FIG. 4; and

FIG. 7 is a flow chart illustrating a method of recording a signal using a beam forming algorithm according to an embodiment of the present general inventive concept.

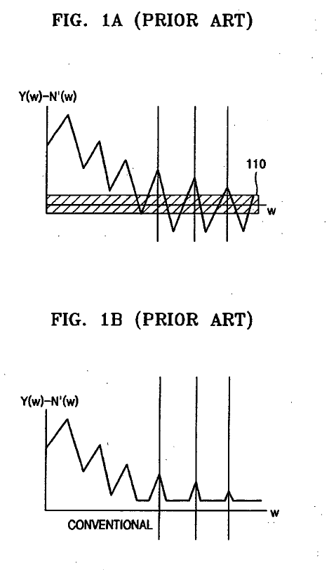

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

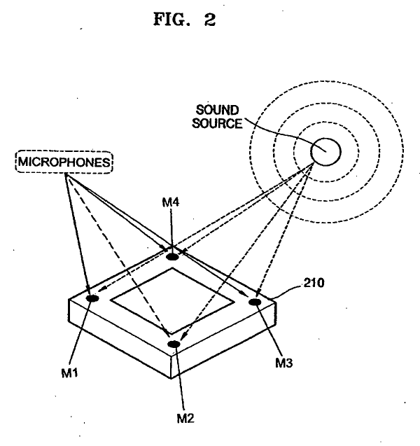

FIG. 2 is a view of an apparatus 210 to record a signal using a beam forming algorithm according to an embodiment of the present general inventive concept.

Referring to FIG. 2, the apparatus 210 includes a microphone array and adopts the beam forming algorithm to receive an audio signal which is mixed with a directional noise or a background noise and remove noise from the received audio signal. The beam forming algorithm is a noise removal method having a high sensitivity. The microphone array may include four microphones M1, M2, M3, and M4 mounted according to a predetermined geometrical arrangement in the apparatus 210 to receive the audio signal from a sound source. The sound source may be positioned at a relative long distance from the apparatus 210. A user can adjust the number of microphones used in a recording operation and positions of the microphones to obtain better focusing of the sound source. The apparatus may be a voice recorder, a Moving Pictures Expert Group audio layer 3 (MP3), etc.

The beam forming algorithm can reduce a spatial relevant noise when a direction of a desired sound signal and a direction of a noise signal are different, by giving an appropriate amount of weight to the microphone array and amplifying the desired sound signal.

The microphones M1, M2, M3, and M4 are placed at different distances from the sound source. Thus, a sound wave generated by the sound source reaches each of the microphones M1, M2, M3, and M4 after different time periods. Consequently, the waveforms at each of the microphones M1, M2, M3, and M4 can be matched by calculating the differences among the arrival times of the sound waves of microphones and compensating the delays of the sound waves when a location of the sound source is known. The microphones M1, M2, M3, and M4 receive the sound waves from the sound source and produce audio signals.

Referring to FIG. 2, each of the audio signals input via the microphones M1, M2, M3, and M4 has a time difference (i.e., a delay time) because of a phase difference between the audio signals of the microphones M1, M2, M3, and M4. The time difference occurs because the sound wave propagation times are different corresponding to the different distances from the sound source. The amplitudes of each of the audio signals are changed by the delay time. Therefore, a beam that indicates a recording area where the sound source is located can be adjusted by adjusting the delay time and a level of each of the audio signals input via the microphones M1, M2, M3, and M4. The recording area can be indicated by selecting an angle and a width of the beam.

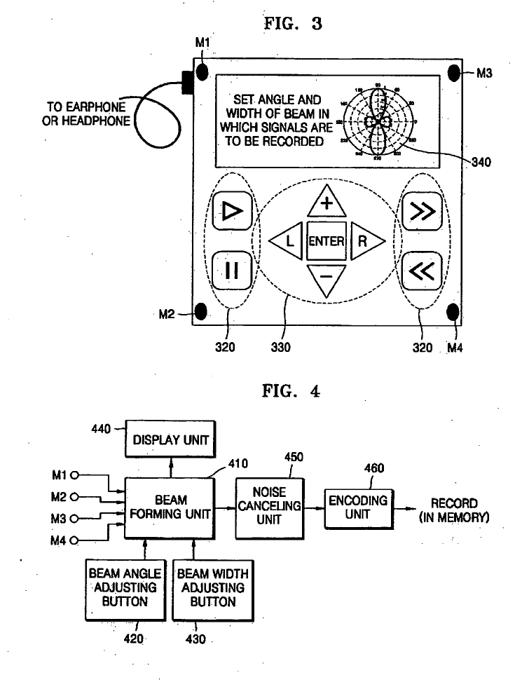

FIG. 3 is a front view of the apparatus 210 of FIG. 2.

Referring to FIG. 3, the apparatus 210 includes the four microphones M1, M2, M3, and M4, common sound reproducing buttons 320, adjusting buttons 330 to adjust a beam, and a beam display window 340 to display the beam.

The common sound reproducing buttons 320 are used to select recording or reproducing a sound in or from a memory. The buttons 330 to adjust the beam adjusts the angle and the width of the beam via adjustment buttons (+, −, R, L, and ENTER). Here, the angle and/or the width of the adjusted beam are illustrated in the beam display window 340. The beam display window 340 displays a beam graph illustrating a recording area in addition to an on-screen display (OSD) related to the beam adjustment.

FIG. 4 is a block diagram of the apparatus 210 of FIG. 2. The apparatus 210 includes the microphones M1, M2, M3, and M4 that are mounted according to a predetermined geometrical arrangement thereon, a beam forming unit 410, a beam angle adjusting button 420, a beam width adjusting button 430, a display unit 440, a noise canceling unit 450, and an encoding unit 460. The noise canceling unit 450 is optional. Here, locations of the microphones M1, M2, M3, and M4 are fixed. However, the number of the microphones used in a recording operation can be adjusted by further including microphone enable and/or disable switches.

The beam forming unit 410 receives an audio signal through each of the microphones M1, M2, M3, and M4, calculates a correlation among the audio signals input through the microphones M1, M2, M3, and M4, and calculates a delay time for each of the audio signals. Reference delay and level values input by the beam angle adjusting button 420 and the beam width adjusting button 430 are considered in the calculated delay times, thereby adjusting the delay time and the level of each of the audio signals and forming a beam by combining the audio signals.

The beam angle adjusting button 420 adjusts the angle of the beam by adjusting the delay time of each of the audio signals of the beam forming unit 410.

The beam width adjusting button 430 adjusts the width of the beam by adjusting the delay time and the level of each of the audio signals of the beam forming unit 410. That is, the angle and width of the beam can be calculated and/or adjusted according to the reference delay time and the level value.

The display unit 440 displays a beam pattern formed by the beam forming unit 410. In addition, the display unit 440 displays the beam pattern adjusted by the beam angle adjusting button 420 and the beam width adjusting button 430.

The noise canceling unit 450 removes noise components included in the audio signal output from the beam forming unit 410 using a noise cancellation algorithm such as a spectral subtraction method.

The encoding unit 460 encodes a sound source signal output from the noise canceling unit 450 into a predetermined compression format, the sound source signal having noise removed therefrom through the beam forming algorithm and the noise cancellation algorithm.

Finally, the signal encoded at the encoding unit 460 is recorded in a recording medium such as a memory.

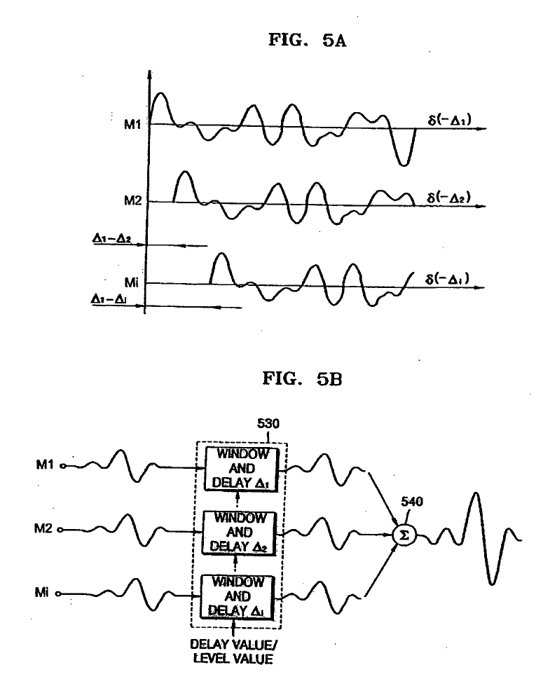

FIG. 5A shows waveforms and delay times of audio signals produced by microphones M1, M2, . . . , Mᵢ after receiving respective waves (sound signals) corresponding to the respective audio signals according to an embodiment of the present general inventive concept.

Referring to FIG. 5A, the sound signal emitted from a sound source propagates in different propagation times to microphones M1, M2, . . . , Mᵢ of a microphone array. The sound signal emitted from the sound source is delayed by propagating different distances to the microphones. A first audio signal from the microphone M1 at a time Δ₁ corresponds to a first sound signal, a second audio signal is from the microphone M2 at a time Δ₂ corresponds to a second sound signal, and Δ₂>Δ₁ since the microphone M2 is placed farther away from the sound source than the first microphone M1. Therefore, the first and second audio signals produced by the first and second microphones M1 and M2, respectively, have a time difference Δ₂−Δ₁.

FIG. 5B is a detailed view of the beam forming unit 410 of the apparatus of FIG. 4.

Referring to FIG. 5B, a delay processing unit 530 is connected to a plurality of microphones M1, M2, . . . , Mᵢ, and receives an audio signal from each of the microphones M1, M2, . . . , Mᵢ. The delay processing unit 530 determines a correlation among the audio signals that are input through the microphones M1, M2, . . . , Mᵢ, calculates a delay time for each of the audio signals, and delays each of the audio signals according to the calculated delay time. In addition, the delay processing unit 530 adjusts a delay and a level of each of the audio signals when the delay and/or the level value corresponding to an angle and/or a width adjustment of a beam is input by a user.

An adding unit 540 adds each of the audio signals with the delay and/or the level adjusted, and forms the beam that indicates an area in which wave forms corresponding to the audio signals are to be received. That is, a shape of each beam pattern of the beam represents the area of the audio signal received by the microphones.

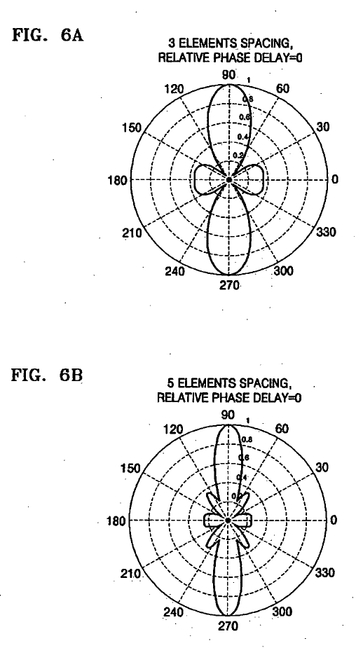

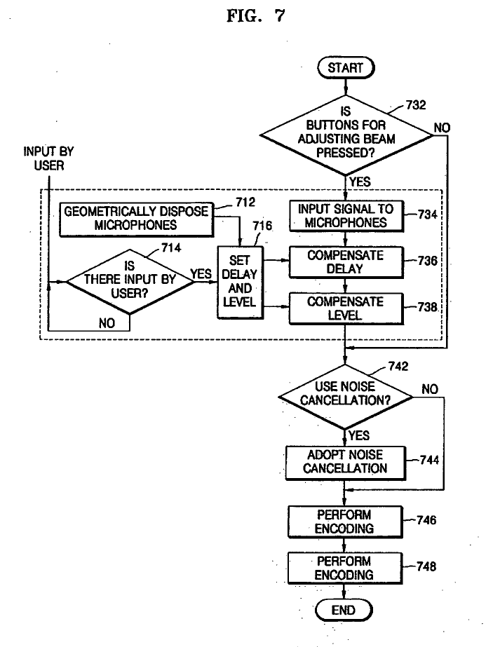

FIGS. 6A and 6B are views of beam forming patterns of the beam forming unit 410 represented in FIG. 4.

Referring to FIGS. 6A and 6B, the angle and the width of the beam can be changed depending on the number of microphones used in a recording operation. In addition, the angle and the width of the beam can be altered by a user by adjusting delay times of the audio signals and levels of the audio signals according to the location of the microphones with respect to the sound source or a position of the apparatus 210.

FIG. 7 is a flow chart illustrating a method of recording a signal using a beam forming algorithm according to an embodiment of the present general inventive concept.

First, a plurality of microphones that receive a signal output from a sound source and produce audio signals are disposed on a recording and/or reproducing apparatus (operation 712).

Then it is determined whether the buttons 330 to adjust a beam are pressed by the user (operation 732).

Then, if the buttons 330 to adjust the beam are pressed by the user, the signal output from the sound source is input to each of the microphones (operation 734).

Here, it is checked whether a signal output by the beam angle adjusting button 420 or the beam width adjusting button 430 is received (operation 714). If the signal output by the beam angle adjusting button 420 or the beam width adjusting button 430 is received, delay times and level values to be applied to each audio signal corresponding to the angle and/or width of the beam are set (operation 716).

Then, the audio signals input by each of the microphones are delayed and added to form the beam. Here, the angle and the width of the beam, which indicates a recording area where the audio signal is received and generated with respect to the sound source, are adjusted by compensating the delay and the level of the signal input to each of the microphones according to the delay and level values of the signal that corresponds to the angle and/or the width of the beam (operation 734 and operation 736).

Then, it is determined whether a noise cancellation algorithm, such as spectral subtraction, is adopted additionally (operation 742). Here, if the noise cancellation algorithm is adopted, a noise cancellation operation, such as a spectral subtraction, is performed to further reduce the noise (operation 744). That is, the audio signal is output from the beam forming unit 410 to the noise canceling unit 450 to remove the noise from the audio signal.

The audio signal with the noise removed by the beam forming algorithm and the noise cancellation algorithm is encoded into a predetermined compression format (operation 746).

The encoded audio signal is recorded in a recording medium such as a memory (operation 748).

According to the present general inventive concept as described above, a surrounding unwanted sound and noise besides a signal of a sound source that is the object of recording are eliminated during a recording stage by adopting a beam forming algorithm in a portable apparatus to record or to reproduce a signal in which a recording function is embedded. Moreover, by additionally using a noise cancellation algorithm besides the beam forming algorithm, the unwanted noise of the recorded signal is further reduced. Furthermore, a user can adjust a direction and a width of a beam, which indicates a recording area, according to the location of the sound source that produces the sound to be recorded.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

The general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled to computer systems so that the computer readable code can be stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of recording an audio signal, comprising:
receiving the audio signal through each of a plurality of microphones disposed at predetermined locations;
forming a beam from the audio signal received through each of a plurality of microphones by adjusting a delay and a level of the audio signal received through each of the plurality of microphones; and
adjusting an angle and a width of the beam by a user.

2. The method of claim 1, wherein in the adjusting of the angle and the width of the beam, the delay and the level of each audio signal received through each of the plurality of microphones are adjusted by the user.

3. The method of claim 1, wherein the forming of the beam comprises:
calculating a correlation using the audio signal received through each of the plurality of microphones;
calculating delay time between the audio signal received through each of the plurality of microphones;
compensating the delay and the level of the audio signal received through each of the plurality microphones by considering a delay value and a level value input by the user in the calculated delay time; and
adding the audio signal received through each of the plurality of microphones.

4. The method of claim 1, wherein the plurality of microphones are disposed at the predetermined locations on an apparatus.

5. An apparatus to record an audio signal, comprising:
a plurality of microphones that are disposed to predetermined locations to produce audio signals upon receiving a sound signal;
a beam forming unit which forms a beam from the audio signals by adjusting a delay and a level of each audio signal of the microphones;
a display unit which displays a beam pattern of the beam formed at the beam forming unit; and
a beam angle and/or width adjusting unit which transmits a delay value and a level value of each of the audio signals that correspond to an angle and a width adjustment values of the beam output from the beam forming unit.

6. The apparatus of claim 5, further comprising:
a microphone enable/disable switch which controls the plurality of microphones to be selectively turned on and off.

7. The apparatus of claim 5, wherein the beam forming unit comprises:
a delay processing unit which calculates a correlation among the audio signals that are produced by each of the plurality of microphones and then calculates delay times between the audio signals, and to compensate the delay and the level of each of the audio signals by considering a delay value and a level value input by a user in the calculated delay time; and
an adding unit which adds the audio signals delayed at the delay processing unit and to form the beam that indicates an area of a sound source from which the sound signal is received.

8. The apparatus of claim 5, further comprising:
a noise cancellation unit which removes noise from the audio signal output by the beam forming unit.

9. The apparatus of claim 5, wherein the angle and/or width adjusting unit comprises:
a beam angle adjusting button which adjusts the delay of the audio signal produced by each of the microphones at the beam forming unit; and
a beam width adjusting button which adjusts the delay and the level of the audio signal produced by each of the microphones at the beam forming unit.

10. An apparatus to record a signal, the apparatus comprising:
a plurality of microphones to receive sound signals from a sound source and to generate audio signals corresponding to the respective sound signals;
a beam forming unit to adjust the audio signals according to corresponding ones of predetermined delay values and level values of the respective audio signals; and
a recording unit to record a signal formed from the adjusted audio signals.

11. The apparatus of claim 10, further comprising:
a display unit to display a beam representing the delay values and level values.

12. The apparatus of claim 11, further comprising:
a user interface to allow a user to indicate a position of the sound source with respect to the plurality of microphones, by inputting values for a beam angle and a beam width of the beam.

13. The apparatus of claim 12, wherein the display unit comprises a window to display a shape of the beam having the beam angle and the beam width according to the position, the delay values and the level values.

14. The apparatus of claim 10, further comprising:
a pre-recording processing unit to filter noise from the signal formed from the adjusted audio signals.

15. The apparatus of claim 14, wherein the pre-recording processing unit filters noise by applying a spectral subtraction method.

16. The apparatus of claim 10, further comprising:
an encoding unit to compress the signal,
wherein the recording unit records the compressed signal.

17. The apparatus of claim 10, further comprising:
a user interface to allow a user to select using at least two microphones from the plurality of microphones.

18. The apparatus of claim 10, further comprising:
a user interface to allow a user to choose the number of microphones to be used.

19. The apparatus of claim 10, further comprising:
a user interface including a plurality of switches corresponding to the plurality of microphones to allow a user to switch on/off any microphone.

20. A method of recording a signal, the method comprising:
receiving sound signals from a sound source and generating audio signals corresponding to the respective sound signals;
adjusting the audio signals according to corresponding ones of predetermined delay values and level values of the audio signal; and
recording a signal formed from the adjusted audio signals.

21. A computer readable storage medium having executable codes to perform a method of recording an audio signal, the method comprising:
receiving sound signals from a sound source and generating audio signals corresponding to the respective sound signals;
adjusting the audio signals according to corresponding ones of predetermined delay values and level values of the audio signal; and
recording a signal formed from the adjusted audio signals.

22. The computer readable storage medium having executable codes to perform a method of recording an audio signal of claim 18, the method further comprising:
filtering unwanted noise from the audio signal before recording using a spectral subtraction method.

23. The computer readable storage medium having executable codes to perform a method of recording an audio signal of claim 21, the method further comprising:
compressing the audio signal before recording.

24. A computer readable storage medium having executable codes to perform a method of recording an audio signal, the method comprising: disposing a plurality of microphones at a plurality of predetermined locations to generate audio signals upon receiving a sound signal output from a sound source;
forming a beam from the audio signals by adjusting a delay and a level of audio signal of each of the plurality of microphones; and
adjusting an angle and a width of the beam by a user.
